(19) United States
(12) Patent Application Publication
(10) Pub. No.: US 2022/0284411 A1
(43) Pub. Date: Sep. 8, 2022

(54) SETTLEMENT DEVICE AND PROGRAM

(71) Applicant: Toshiba Tec Kabushiki Kaisha, Tokyo (JP)

(72) Inventor: Yuki SUZUKI, Izunokuni (JP)

(73) Assignee: Toshiba Tec Kabushiki Kaisha, Tokyo (JP)

(21) Appl. No.: 17/560,527

(22) Filed: Dec. 23, 2021

(30) Foreign Application Priority Data
Mar. 5, 2021 (JP) 2021-035406

(51) Int. Cl. G06Q 20/20; G06Q 20/18; G06K 7/10

(52) U.S. Cl. CPC G06Q 20/201; G06Q 20/208; G06Q 20/18; G06K 7/10366

(57) ABSTRACT

A settlement device includes a scale that measures a first total weight of commodities; a wireless tag reader that reads, from a wireless tag attached to each of the commodities, a commodity code; and a camera that acquires an image of the commodities. A controller is configured to register the commodity codes; calculate, based on data that correlates commodity codes and commodity weights, a second total weight of the commodities corresponding to the commodity codes registered by the controller; recognize the commodities from the image; when the first total weight and second total weight do not coincide, register an additional commodity code that (a) was not read by the wireless tag reader and (b) correlates to one of the commodities recognized from the image; and when the first total weight and the second total weight coincide, perform settlement processing for the registered commodities.

### CROSS-REFERENCE TO RELATED APPLICATION

This application is based upon and claims the benefit of priority from Japanese Patent Application No. 2021-035406, filed on Mar. 5, 2021, the entire contents of which are incorporated herein by reference.

### FIELD

Embodiments described herein relate generally to a settlement device and a program.

### BACKGROUND

Some self-service checkout terminals are each capable of collectively performing registration of a plurality of commodities by collectively reading the plurality of commodities attached with wireless tags such as Radio Frequency Identifiers (RFIDs). There has been proposed a self-service check terminal that checks the number of items of a commodity by measuring the weight of the commodity for the purpose of assisting commodity registration by a wireless tag.

However, in the self-service checkout terminals of related art, if wireless tags are read, a wireless tag sometimes cannot be read because of an arrangement or the like of a commodity, that is, an unread wireless tag sometimes occurs. In order to reduce occurrence of misreading of a wireless tag attached to a commodity in the periphery, an output of a radio wave of an RFID is reduced. However, even in this case, an unread wireless tag sometimes occurs.

Related art is described in, for example, JP-A-2013-73296.

### DESCRIPTION OF THE DRAWINGS

FIG. 1 is a perspective view illustrating an example of the exterior of a self-service checkout device according to an embodiment;

FIG. 2 is a diagram illustrating an example of a data structure of a memory included in a wireless tag according to the embodiment;

FIG. 3 is a block diagram illustrating an example of a hardware configuration of the self-service checkout device;

FIG. 4 is a functional configuration diagram illustrating an example of functions of a settlement device according to the embodiment;

FIG. 5 is a diagram schematically illustrating an example of a state in which an imaging region of a camera of the self-service checkout device is viewed from above; and

FIG. 6 is a flowchart illustrating an example of processing executed by the self-service checkout device.

### DETAILED DESCRIPTION

An object of embodiments is to provide, in order to solve the problems described above, a settlement device that can efficiently perform collective registration of commodities.

A settlement device according to an embodiment includes: a scale configured to measure a first total weight of a plurality of commodities placed on the scale; a wireless tag reader configured to read, from a wireless tag attached to each of the commodities placed on the scale, a commodity code for identifying the corresponding commodity; a camera configured to acquire an image of the commodities placed on the scale, and a controller. The controller is configured to register the commodity codes read by the wireless tag reader; calculate, based on data that correlates commodity codes and commodity weights, a second total weight of the commodities corresponding to the commodity codes registered by the controller; recognize the commodities placed on the scale from the image; when the first total weight measured by the scale and second total weight calculated by the controller do not coincide, register an additional commodity code that (a) was not read by the wireless tag reader and (b) correlates to one of the commodities recognized from the image; and when the first total weight measured by the scale and the second total weight calculated by the controller coincide, perform settlement processing for the registered commodities.

An embodiment of a settlement device is explained in detail below with reference to the accompanying drawings. In this embodiment, an example is explained in which the settlement device is applied to a self-service checkout device with which a customer himself or herself performs commodity registration and settlement. However, embodiments are not limited to this embodiment.

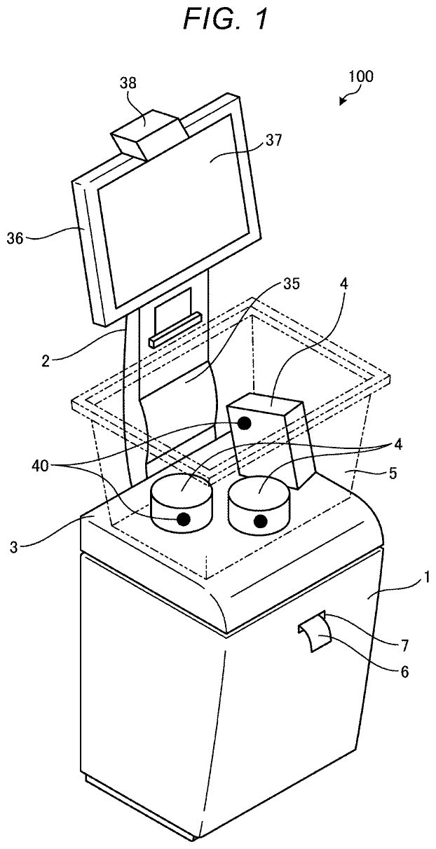

FIG. 1 is a perspective view illustrating an example of the exterior of a self-service checkout device 100 according to the embodiment. As illustrated in FIG. 1, the self-service checkout device 100 is configured by a main body base 1 (e.g., a base) set on a floor surface and a main body upper part 2 (e.g., a user interface portion) extending above the main body base 1. The main body base 1 includes a scale unit 33 (e.g., a scale, a weight sensor, etc.) and a printer 34 (see FIG. 3).

A placing section 3 (e.g., a countertop, a weighing area, a product support area, a product placement area, etc.), which is a scale pan of the scale unit 33 explained below, is disposed on the upper surface of the main body base 1. The placing section 3 is configured in a shape and a size for enabling a basket 5 (e.g., a container), which stores one or a plurality of commodities 4 (e.g., items for purchase) about to be purchased by a customer, to be placed on the placing section 3. That is, the plurality of commodities 4 can be placed on the placing section 3. The scale unit 33 is located below the placing section 3 and incorporated in the main body base 1.

A dispensing port 7 (e.g., a dispenser, a printer outlet, etc.) for dispensing a receipt 6 is disposed on the front side of the main body base 1. The printer 34 that outputs the receipt 6 is disposed on the depth side of the dispensing port 7 (e.g., on the interior side of the dispensing port 7).

The main body upper part 2 includes a wireless tag reader writer 35, a monitor 36 (e.g., a display, a user interface), which is a display unit, an input unit included in the display unit, for example, a touch panel 37 (e.g., a user interface) disposed to be stacked on the display unit, and an imaging unit, for example, a camera 38 provided above the display unit. The wireless tag reader writer 35 may be provided below the placing section 3 of the main body base 1.

The wireless tag reader writer 35 (e.g., a wireless tag reader and/or a wireless tag writer) includes an antenna and detects a wireless tag 40 attached to a commodity 4 present in a communication region range of the antenna. That is, the wireless tag reader writer 35 transmits a radio wave from the antenna to the wireless tag 40 in the periphery. If receiving the radio wave from the antenna, the wireless tag 40 transmits a response signal to the wireless tag reader writer 35.

The wireless tag reader writer 35 receives the response signal transmitted from the wireless tag 40 to thereby read tag information stored in a memory of the wireless tag 40. A scheme called anticollision (e.g., collision prevention) is used for communication control between the wireless tag reader writer 35 and the wireless tag 40. Consequently, if a plurality of wireless tags 40 are present in a communicable region of the antenna, tag information of the wireless tags 40 is collectively read by the wireless tag reader writer 35.

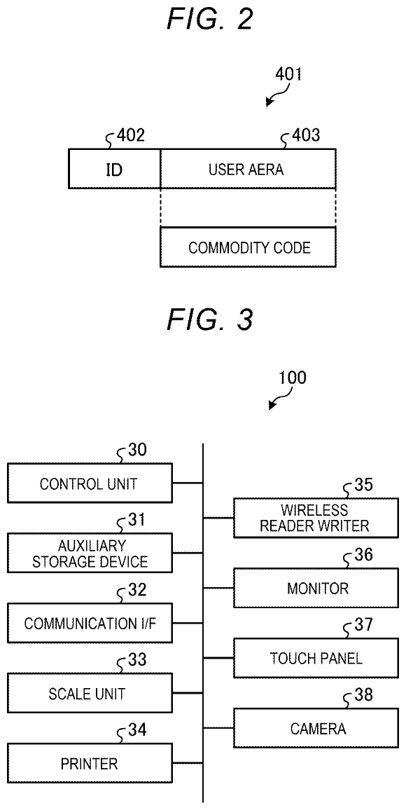

A data structure of a memory 401 included in the wireless tag 40 is explained with reference to FIG. 2. The wireless tag 40 includes a nonvolatile memory 401 on the inside thereof. In the memory 401, an ID area 402 for storing a specific identifier (ID) allocated and set by a manufacturer at a manufacturing stage of the wireless tag 40 and a user area 403 in which a user can write any data are formed.

In this embodiment, in a user area 403 of the wireless tag 40 attached to each of the commodities 4, as information concerning the commodity 4 to which the wireless tag 40 is attached, a commodity code capable of identifying the commodity 4 is written. The wireless tag reader writer 35 reads the ID and the commodity code from the wireless tag 40 as tag information. The wireless tag reader writer 35 performs redundancy check based on the ID included in the read tag information to perform control not to redundantly read the tag information (the commodity code) including the same ID. In the self-service checkout device 100, registration processing and settlement processing for the commodity 4 can be performed based on the commodity code read by the wireless tag reader writer 35.

Referring back to FIG. 1, the monitor 36 is provided above the wireless reader writer 35. The monitor 36 displays an image according to control by a control unit 30 explained below. The touch panel 37 is provided on the surface of the monitor 36 and outputs information based on a position touched by an operator to the control unit 30.

The camera 38 is provided above the monitor 36. The camera 38 images the placing section 3. For example, the camera 38 images the basket 5 storing one or a plurality of commodities 4 about to be purchased by a customer. The camera 38 only has to be present in a position where the camera 38 can image the placing section 3 and may be disposed in a position other than above the monitor 36.

A hardware configuration of the self-service checkout device 100 is explained. FIG. 3 is a block diagram illustrating an example of the hardware configuration of the self-service checkout device 100.

As illustrated in FIG. 3, the self-service checkout device 100 includes the control unit 30 (e.g., a controller), an auxiliary storage device 31 (e.g., a memory), a communication I/F 32 (e.g., a communication interface, a network interface, etc.), the scale unit 33, the printer 34, the wireless tag reader writer 35, the monitor 36, the touch panel 37, and the camera 38.

The control unit 30 includes a Central Processing Unit (CPU), a Read-Only Memory (ROM), and a Random Access Memory (RAM). The ROM (e.g., a non-transitory recording medium) stores various data including a program for starting the self-service checkout device 100 (e.g., information and the like written at a manufacturing stage of the self-service checkout device 100). The RAM temporarily stores data and a computer program if the CPU, which is an example of the processor (e.g., one or more processors), executes the computer program.

The auxiliary storage device 31 stores various data such as a program to be executed by the CPU. The auxiliary storage device 31 is configured as, for example, a Hard Disc Drive (HDD). The communication I/F 32 is an interface for transmitting and receiving data and performs data communication with various external devices such as a server. The scale unit 33 measures the weight of an article in the basket 5 placed on the placing section 3 for the purpose of fraud prevention and the like.

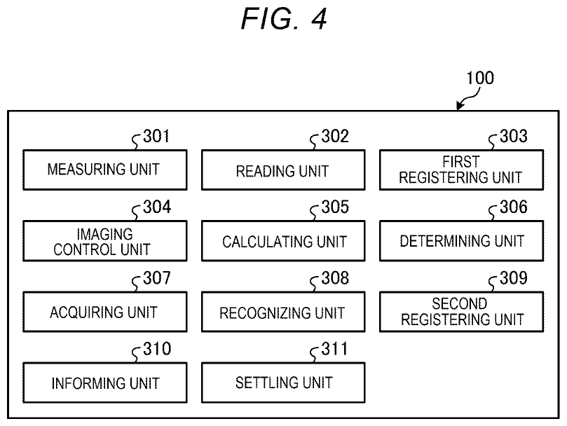

A functional configuration of the control unit 30 of the self-service checkout device 100 according to the embodiment is explained. FIG. 4 is a block diagram illustrating an example of a functional configuration of the self-service checkout device 100. The CPU operates according to a control program stored in the ROM or the RAM, whereby the control unit 30 functions as a measuring unit 301, a reading unit 302, a first registering unit 303, an imaging control unit 304, a calculating unit 305, a determining unit 306, an acquiring unit 307, a recognizing unit 308, an informing unit 310, a second registering unit 309, and a settling unit 311. The functional components may be realized by hardware. The self-service checkout device 100 only has to include the functions.

The measuring unit 301 is an example of measuring means. The measuring unit 301 cooperates with the scale unit 33 to perform processing for measuring the weight of a purchase target commodity placed on the placing section 3. For example, if the basket 5 storing the commodity 4 is placed on the placing section 3, the measuring unit 301 detects (e.g., acquires) the weight of the commodity 4 in the basket 5 via (e.g., measured by) the scale unit 33. The weight of the basket 5 is stored in a storing unit such as the auxiliary storage device 31 in advance. The weight of the basket 5 is not included in the weight of the commodity 4 (e.g., the weight of the basket 5 is automatically subtracted from the weight measurement provided by the scale unit 33). If detecting the weight of the commodity 4 placed on the placing section 3 via the scale unit 33, the measuring unit 301 temporarily stores a measurement value, which is the detected weight, in the RAM. In the following explanation, the weight acquired by the measuring unit 301 is referred to as measured weight.

The reading unit 302 is an example of reading means. The reading unit 302 cooperates with the wireless tag reader writer 35 to perform processing for reading, from the wireless tag 40 attached to the commodity 4, tag information including a commodity code for identifying the commodity 4. For example, if weight is detected by the measuring unit 301, by causing the wireless tag reader writer 35 to operate, the reading unit 302 starts reading of the wireless tag 40 and acquires the tag information (e.g., the commodity code) read by the wireless tag reader writer 35. That is, if the basket 5 is placed on the placing section 3 and the scale unit 33 detects that weight increases, the self-service checkout device 100 in this embodiment reads the wireless tag 40 attached to the commodity 4 in the basket 5. Therefore, the wireless tag reader writer 35 does not need to always output a reading radio wave for wireless tag reading.

The first registering unit 303 is an example of first registering means. The first registering unit 303 performs processing for registering a commodity corresponding to a commodity code read by the reading unit 302. For example, if a commodity code is read from the wireless tag 40 according to control of the reading unit 302, the first registering unit 303 registers commodity information of a commodity corresponding to the commodity code in the RAM or the like together with the commodity code.

Specifically, if a commodity code is read by the reading unit 302, the first registering unit 303 refers to a Price Look Up (PLU) file stored in a storing unit of the self-service checkout device 100 or an external device connected online. The PLU file is a file in which names, prices, and weights of commodities (i.e., commodity weights) (e.g., known commodities or predetermined commodities having known or predetermined names, prices, and weights), commodity images showing exterior characteristics of the commodities, and the like are recorded in correlation with commodity codes.

The first registering unit 303 acquires, about each of commodity codes read by the reading unit 302, a name, a price, weight, and the like of a commodity corresponding to the commodity code as commodity information. The first registering unit 303 registers, in correlation with each of the commodity codes read by the reading unit 302, the commodity information of the commodity corresponding to the commodity code in the RAM or the like. The first registering unit 303 may register, instead of the commodity code, tag information including an ID.

The imaging control unit 304 is an example of imaging control means. The imaging control unit 304 performs, using the camera 38, processing for imaging the commodity 4 placed on the placing section 3. For example, if weight is detected by the measuring unit 301, the imaging control unit 304 controls the camera 38 to start imaging of the commodity 4 placed on the placing section 3. If the determining unit 306 explained below determines that total weight calculated by the calculating unit 305 and measured weight acquired by the measuring unit 301 do not coincide, the imaging control unit 304 may start imaging of the commodity 4 placed on the placing section 3.

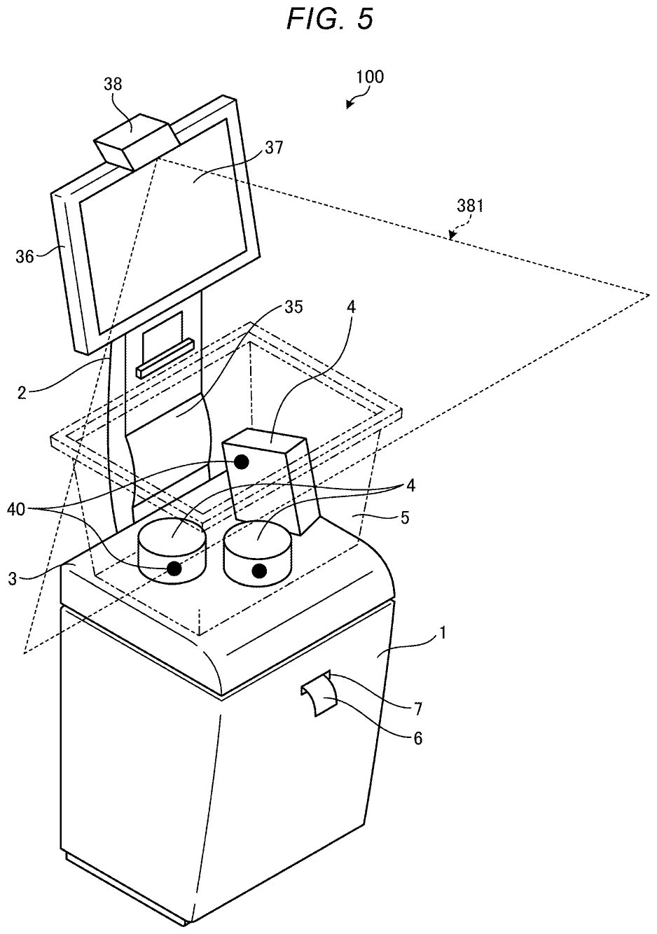

An imaging region of the camera 38 of the self-service checkout device 100 is explained with reference to FIG. 5. FIG. 5 is a diagram schematically illustrating an example of a state in which the imaging region of the camera 38 of the self-service checkout device 100 is viewed from above.

The camera 38 images an imaging region 381. The imaging region 381 includes the placing section 3 provided in the self-service checkout device 100. That is, the camera 38 is provided in a position where the camera 38 is capable of imaging the placing section 3 provided in the self-service checkout device 100. The camera 38 is preferably provided in a position where the camera 38 is capable of imaging, from above, on the placing section 3, the basket 5 storing one or a plurality of commodities 4 that the customer is about to purchase.

Referring back to FIG. 3, the calculating unit 305 is an example of calculating means. The calculating unit 305 calculates, based on data correlating the commodity codes and the weights of the commodities 4 registered by the first registering unit 303, total weight of the commodities 4 corresponding to the registered commodity code. Specifically, the calculating unit 305 calculates, from the weight of the commodity 4 corresponding to each of the commodity codes registered by the first registering unit 303, first weight of the commodities 4 registered by reading of the wireless tags 40. The calculating unit 305 calculates second weight obtained by adding up first total weight of the commodity 4 corresponding to each of the commodity codes registered by the first registering unit 303 and total weight of the commodities 4 additionally registered by the second registering unit 309 explained below.

The determining unit 306 is an example of determining means. The determining unit 306 determines whether the first weight calculated by the calculating unit 305 and the measured weight acquired by the measuring unit 301 coincide. The determining unit 306 determines whether the second weight calculated by the calculating unit 305 and the measured weight measured by the measuring unit 301 coincide. In this embodiment, “coincide” is not limited to complete coincidence and includes, for example, a concept of “substantial coincidence” for determining coincidence within a predetermined error range. By way of example, the determining unit 307 may determine that the second weight coincides with the first weight if the second weight is within ten percent (e.g., ±10%) of the first weight.

The acquiring unit 307 is an example of acquiring means. The acquiring unit 307 performs processing for acquiring a captured image captured by the camera 38. Specifically, the acquiring unit 307 acquires an image showing the commodity 4 in the basket 5 captured by the camera 38 and stores the image in the RAM or the like of the control unit 30.

The recognizing unit 308 is an example of recognizing means. The recognizing unit 308 performs, based on the image of the commodity 4 acquired by the acquiring unit 307, processing for recognizing the commodity 4 placed on the placing section 3. Specifically, the recognizing unit 308 refers to the PLU file explained above and retrieves, out of a commodity image showing a form of the commodity 4 stored in the PLU file, a commodity image similar to characteristics (e.g., a shape, a color, a pattern, and the like) in the exterior of the commodity 4 shown in the image. If a commodity image having a similarity degree equal to or larger than a threshold is present, the recognizing unit 308 acquires, as a recognition result, a commodity code and weight corresponding to the relevant commodity information. As a method of calculating and determining a similarity degree to the commodity image, a publicly-known technique such as image recognition can be used.

The recognizing unit 308 executes, according to a determination result of the determining unit 306, processing for recognizing the commodity 4 explained above. Specifically, if the determining unit 306 determines that the first weight calculated by the calculating unit 305 and the measured weight acquired by the measuring unit 301 do not coincide, the recognizing unit 308 executes the processing for recognizing the commodity 4 explained above.

The second registering unit 309 is an example of second registering means. The second registering unit 309 performs processing for additionally registering a commodity not registered by the first registering unit 303 among commodities recognized by the recognizing unit 308. Specifically, the second registering unit 309 compares commodity codes corresponding to the commodities recognized by the recognizing unit 308 and registered commodity codes registered by the first registering unit 303.

If a commodity code other than the registered commodity codes is present among the commodity codes of the commodities recognized by the recognizing unit 308, the second registering unit 309 additionally registers the commodity code in the RAM or the like as a commodity code of an unregistered commodity. Like the first registering unit 303, the second registering unit 309 performs processing relating to registration of a commodity using the PLU file. The registration by the first registering unit 303 and the registration by the second registering unit 309 are preferably retained in an identifiable state.

The informing unit 310 is an example of informing means. The informing unit 310 performs processing for informing (e.g., provides a notification to a user) based on the determination result of the determining unit 306. Specifically, the informing unit 310 informs if, from the determination result of the determining unit 306, the second weight calculated by the calculating unit 305 and the measured weight measured by the measuring unit 301 do not coincide. For example, the informing unit 310 outputs content for informing that the weights do not coincide to the monitor 36 of the self-service checkout device 100 and displays a message such as “please align commodities because a part of the commodities cannot be read” or “please move the basket a little to the left or the right” on the monitor 36. Accordingly, the message may include an instruction for the user to rearrange one or more of the commodities in the basket 5. Consequently, by being informed, the customer can grasp that the commodity in the basket 5 cannot be read. If the state is solved after the informing, the self-service checkout device 100 can image the commodity with the camera 38 or read the commodity again.

The informing unit 310 may also inform if the first weight calculated by the calculating unit 305 and the measured weight acquired by the measuring unit 301 do not coincide.

The settling unit 311 is an example of settling means. The settling unit 311 executes, according to the determination result of the determining unit 306, settlement processing for performing settlement (e.g., checkout) of a commodity registered in the RAM or the like. Specifically, if the first weight calculated by the calculating unit 305 and the measured weight measured by the measuring unit 301 coincide, the settling unit 311 executes settlement processing for the commodity registered by the first registering unit 303. If the second total weight calculated by the calculating unit 305 and the measured weight measured by the measuring unit 301 coincide, the settling unit 311 performs settlement processing for the commodity registered by the first registering unit 303 and the commodity registered by the second registering unit 309.

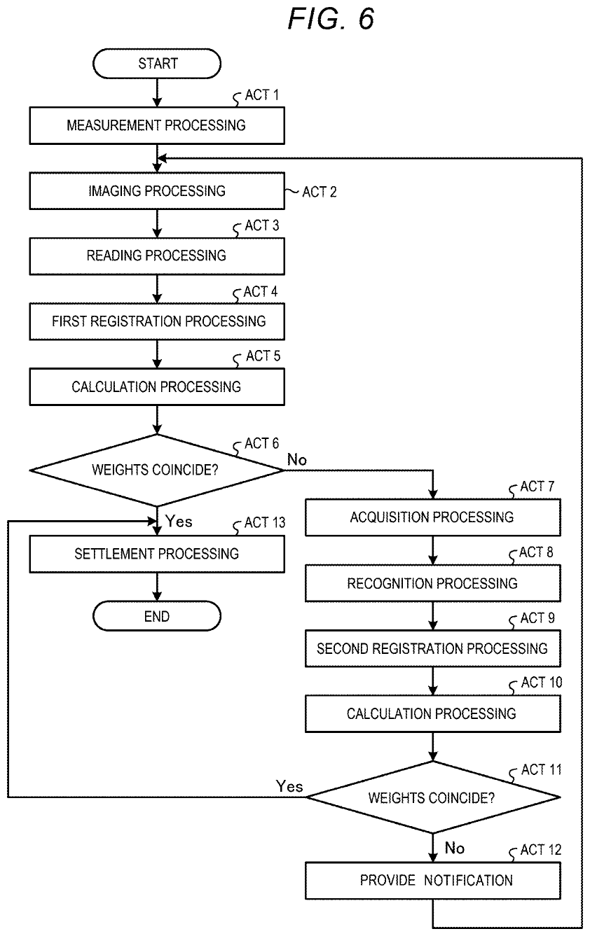

Subsequently, an operation example of the self-service checkout device 100 having the configuration explained above is explained with reference to FIG. 6. FIG. 6 is a flowchart illustrating an example of processing executed by the self-service checkout device 100 in the embodiment.

First, if the basket 5 storing the commodities 4 is placed on the placing section 3, the measuring unit 301 detects the weight of the commodities 4 in the basket 5 via the scale unit 33. After the detection of the weight, the measuring unit 301 temporarily stores a measurement value, which is the detected commodity weight of all the commodities 4 in the basket 5, in the RAM of the control unit 30 (Act 1).

At timing when the commodity weight of all the commodities 4 in the basket 5 is measured by the measuring unit 301, the imaging control unit 304 performs processing for causing the camera 38 to image the commodity 4 placed on the placing section 3 (Act 2).

Subsequently, the reading unit 302 causes the wireless tag reader writer 35 to operate and reads, from the wireless tag 40 of the commodity 4 placed on the placing section 3, a commodity code (e.g., tag information) of the commodity 4 (Act 3).

Subsequently, the first registering unit 303 registers, in the RAM or the like, the commodity 4 corresponding to the commodity code read by the reading unit 302 (Act 4). Subsequently, the calculating unit 305 calculates, based on the PLU file or the weight included in the commodity information registered in Act 4, first weight of the commodities 4 registered in Act 4 (Act 5).

Subsequently, the determining unit 306 determines whether the first weight calculated by the calculating unit 305 and the measured weight measured by the measuring unit 301 coincide (Act 6). If the first weight and the measured weight do not coincide (No in Act 6), the processing proceeds to Act 7. On the other hand, if the first weight and the measured weight coincide in Act 6 (Yes in Act 6), the processing proceeds to Act 13.

In Act 7, the acquiring unit 307 acquires a captured image captured by the camera 38 and stores the captured image in the RAM or the like of the control unit 30 (Act 7). Subsequently, the recognizing unit 308 recognizes, from the image stored in Act 7, the commodities 4 shown in the image (Act 8).

Subsequently, the second registering unit 309 additionally registers, in the RAM or the like, an unregistered commodity 4 (e.g., a commodity code) other than the commodity 4 registered in Act 4 among the commodities 4 recognized in Act 8 (Act 9). Subsequently, the calculating unit 305 adds the total weight of the commodities 4 additionally registered in Act 9 to the first weight calculated in Act 5 and calculates second total weight (Act 10).

Subsequently, the determining unit 306 performs determination processing for determining whether the second weight calculated by the calculating unit 305 and the measured weight measured by the measuring unit 301 coincide. If the second weight and the measured weight do not coincide (No in Act 11), the processing proceeds to Act 12. On the other hand, if the second weight and the measured weight coincide in Act 11 (Yes in Act 11), the processing proceeds to Act 13.

In Act 12, according to a determination result of the determining unit 306, the informing unit 310 performs informing for announcing that (e.g., provides a notification indicating that), for example, the weights do not coincide or arrangement of the commodities 4 in the basket 5 is changed (Act 12). Subsequently, the processing proceeds to Act 2 and subsequent acts. The informing unit 310 continues the informing until the total weight and the measured weight coincide.

On the other hand, in Act 13, the settling unit 311 executes settlement processing for performing settlement (e.g., checkout) of the registered commodities 4 (Act 13). If the settlement processing is completed, the processing ends.

As explained above, in the self-service checkout device according to this embodiment, the measuring unit measures total weight of commodities. The first registering unit registers read commodity information. The calculating unit calculates total weight of the registered commodity information. If the measured weight and the calculated weight do not coincide, the second registering unit additionally registers an unregistered commodity and calculates total weight of the commodity information again. Further, if the measured weight and the calculated weight coincide, the settling unit performs settlement processing for the registered commodity.

Consequently, in the self-service checkout device 100, even if the unread commodity 4 that cannot be read by the reading unit 302 (e.g., the wireless reader writer 35) occurs, it is possible to recognize the commodities 4 from an image captured by the camera 38 and additionally register the unread commodity 4. Therefore, in the self-service checkout device 100, if the unread commodity 4 occurs, the unread commodity 4 can be identified from an image recognition result of the commodities 4. Therefore, it is possible to efficiently perform collective registration of commodities.

It is also possible to modify and carry out the embodiment as appropriate by changing a part of the components or the functions of the device explained above. Therefore, in the following explanation, several modifications relating to the embodiment explained above are explained as other embodiments. In the following explanation, differences from the embodiment explained above are mainly explained. Detailed explanation is omitted about similarities to the content explained above. The modifications explained below may be individually carried out or may be carried out in combination as appropriate.

(Modifications)

In the embodiment explained above, if the second weight calculated by the calculating unit 305 and the measured weight measured by the measuring unit 301 do not coincide, after the informing by the informing unit 310, the processing is returned to Act 2. In this case, it is assumed that, since the arrangement of the commodities 4 in the basket 5 is changed by the customer, the wireless tag 40 of the commodity 4 in the unread state changes to a readable state. In that case, it is likely that a commodity code of the unread commodity 4 read anew by the reading unit 302 overlaps a commodity code of the commodity 4 additionally registered by the second registering unit 309.

Therefore, in a modification, if the determining unit 306 determines that the second weight calculated by the calculating unit 305 and the measured weight measured by the measuring unit 301 do not coincide, the second registering unit 309 performs processing for deleting (e.g., cancelling) the additionally registered commodity 4. Consequently, it is possible to avoid the overlap of the commodity code of the unread commodity 4 read anew by the reading unit 302 and the commodity code of the commodity 4 additionally registered by the second registering unit 309. Therefore, it is possible to more efficiently perform the collective registration of commodities.

The computer program executed by the self-service checkout device 100 in this embodiment is provided while being recorded in a computer-readable recording medium (e.g., a non-transitory recording medium) such as a CD-ROM, a flexible disk (FD), a CD-R, or a Digital Versatile Disk (DVD) as a file of an installable format or an executable format.

The computer program executed by the self-service checkout device 100 in this embodiment may be stored on a computer connected to a network such as the Internet and provided by being downloaded through the network. The computer program executed by the self-service checkout device 100 in this embodiment may be provided or distributed through the network such as the Internet.

The computer program executed by the self-service checkout device 100 in this embodiment may be incorporated in the ROM or the like in advance and provided.

Several embodiments are explained above. However, the embodiments are presented as examples and are not intended to limit the scope of the invention. These new embodiments can be implemented in other various forms. Various omissions, substitutions, and changes can be made without departing from the spirit of the invention. These embodiments and modifications of the embodiments are included in the scope and the gist of the invention and included in the inventions described in claims and the scope of equivalents of the inventions.

What is claimed is:

1. A settlement device comprising:
a scale configured to measure a first total weight of a plurality of commodities placed on the scale;
a wireless tag reader configured to read, from a wireless tag attached to each of the commodities placed on the scale, a commodity code for identifying the corresponding commodity;
a camera configured to acquire an image of the commodities placed on the scale; and
a controller configured to:
register the commodity codes read by the wireless tag reader;
calculate, based on data that correlates commodity codes and commodity weights, a second total weight of the commodities corresponding to the commodity codes registered by the controller;
recognize the commodities placed on the scale from the image;
when the first total weight measured by the scale and the second total weight calculated by the controller do not coincide, register an additional commodity code that (a) was not read by the wireless tag reader and (b) correlates to one of the commodities recognized from the image; and
when the first total weight measured by the scale and the second total weight calculated by the controller coincide, perform settlement processing for the registered commodity codes.

2. The settlement device of claim 1, wherein the controller is configured to provide a notification to a user when the first total weight measured by the scale and the second total weight calculated by the controller do not coincide.

3. The settlement device of claim 2, further comprising a display, wherein the notification includes a message provided on the display.

4. The settlement device of claim 3, wherein the message provided on the display includes an instruction for the user to rearrange at least one of the commodities placed on the scale.

5. The settlement device of claim 1, wherein the controller is configured to:
retrieve a commodity image showing a form of a known commodity from a price look up (PLU) file correlated with a commodity code of the known commodity; and
when the image acquired by the camera and the commodity image from the PLU file coincide, acquire the commodity code of the known commodity and a commodity weight of the known commodity.

6. The settlement device of claim 1, wherein the controller is configured to activate the wireless tag reader to begin reading in response to an indication from the scale that the commodities have been placed on the scale.

7. The settlement device of claim 1, wherein the controller is configured to activate the camera to acquire the image in response to an indication that the first total weight measured by the scale and the second total weight calculated by the controller do not coincide.

8. The settlement device of claim 1, wherein the controller is configured to:
calculate a third total weight of the commodities corresponding to the commodity codes read by the wireless tag reader and the additional commodity code; and
if the first total weight measured by the scale and the third total weight calculated by the controller do not coincide, cancel registration of the additional commodity code.

9. A settlement method comprising:
measuring a first total weight of a plurality of commodities placed in a weighing area;
reading, from a wireless tag attached to each of the commodities placed in the weighing area, a commodity code for identifying the corresponding commodity;
registering the read commodity codes;
calculating, based on data that correlates commodity codes and commodity weights, a second total weight of the commodities corresponding to the registered commodity codes;
acquiring, from a camera, an image of the commodities placed in the weighing area;
recognizing the commodities placed in the weighing area from the image;
when the first total weight and the second total weight do not coincide, registering an additional commodity code that (a) was not read from one of the wireless tags and (b) correlates to one of the commodities recognized from the image; and
when the first total weight and the second total weight coincide, performing settlement processing for the registered commodity codes.

10. The settlement method of claim 9, further comprising providing a notification to a user when the first total weight and the second total weight do not coincide.

11. The settlement method of claim 10, wherein the notification is a message provided on a display.

12. The settlement method of claim 11, wherein the message provided on the display includes an instruction for the user to rearrange at least one of the commodities placed in the weighing area.

13. The settlement method of claim 9, further comprising:
retrieving a commodity image showing a form of a known commodity from a price look up (PLU) file correlated with a commodity code of the known commodity, and
when the image acquired by the camera and the commodity image from the PLU file coincide, acquiring the commodity code of the known commodity and a commodity weight of the known commodity.

14. The settlement method of claim 9, wherein reading the commodity codes from the wireless tags is initiated in response to an indication that the commodities have been placed in the weighing area.

15. The settlement method of claim 14, wherein the indication is a change in a measurement of a weight sensor.

16. The settlement method of claim 9, wherein the camera is activated to acquire the image in response to an indication that the first total weight and the second total weight do not coincide.

17. The settlement method of claim 9, further comprising:
calculating a third total weight of the commodities corresponding to the commodity codes read from the wireless tags and the additional commodity code; and
when the first total weight and the third total weight do not coincide, cancelling registration of the additional commodity code.

18. A non-transitory recording medium including instructions stored thereon that, when processed by at least one processor, cause the at least one processor to perform operations comprising:
receiving, from a weight sensor, a measurement of a first total weight of a plurality of commodities placed in a weighing area;
receiving, from a wireless tag reader, commodity codes read from wireless tags attached to each of the commodities;
registering the commodity codes;
calculating, based on data that correlates commodity codes and commodity weights, a second total weight of the commodities corresponding to the registered commodity codes;
receiving, from a camera, an image of the commodities placed in the weighing area;
recognizing the commodities placed in the weighing area from the image;
when the first total weight and the second total weight do not coincide, registering an additional commodity code that (a) was not read from one of the wireless tags and (b) correlates to one of the commodities recognized from the image; and
when the first total weight and the second total weight coincide, performing settlement processing for the registered commodity codes.

19. The non-transitory recording medium of claim 18, wherein the operations performed by the at least one processor further comprise controlling a display to provide a message to a user when the first total weight and the second total weight do not coincide.

20. The non-transitory recording medium of claim 18, wherein the operations performed by the at least one processor further comprise:
retrieving a commodity image showing a form of a known commodity from a price look up (PLU) file correlated with a commodity code of the known commodity; and
when the image received from the camera and the commodity image from the PLU file coincide, acquiring the commodity code of the known commodity and a commodity weight of the known commodity.
